(19) United States
(12) Patent Application Publication
(10) Pub. No.: US 2014/0342808 A1
(43) Pub. Date: Nov. 20, 2014

(54) System and Method of Using PCs as NPCs

(71) Applicant: 2343127 Ontario Inc., Toronto (CA)

(72) Inventors: Yousuf Chowdhary, Maple (CA); Richard Oppus Ople, Markham (CA); Jeffrey Brunet, Aurora (CA); Ravinder ("Ray") Sharma, Toronto (CA)

(21) Appl. No.: 14/217,758

(22) Filed: Mar. 18, 2014

Related U.S. Application Data
(60) Provisional application No. 61/852,568, filed on Mar. 18, 2013.

(51) Int. Cl. A63F 13/00

(52) U.S. Cl. CPC A63F 13/00; A63F 2300/636
USPC 463/24

(57) ABSTRACT

A computer-implemented method of virtual gameplay is provided. In a video game in which a player can create a player character for interaction in the video game, the player is allowed to play in the video game using the player character via at least one player character script. When the player exits the video game, the player character is allowed to at least temporarily become a non-player character in the game by selectively causing the player character to assume at least one non-player character script, such that the player character has automatic, non-player directed interactions in the video game wherein the player character takes on the behaviour of a non-player character. When the player returns to the video game, the player character is allowed to resume play in the video game according to the player character script.

### CROSS-REFERENCE TO RELATED APPLICATION

This application claims the benefit of U.S. Provisional Patent Application Ser. No. 61/852,568, entitled System and Method of Using PCs as NPCs, filed Mar. 18, 2013, the full disclosure of which is incorporated herein by reference in its entirety.

### FIELD OF INVENTION

The present invention is related to video game applications in general and in particular relates to video game applications where player characters can be used as non-player characters.

### BACKGROUND

A virtual world is a computer simulated environment. A virtual world may resemble the real world, with real world rules such as physical rules of gravity, geography, topography, and locomotion. A virtual world may also incorporate rules for social and economic interactions between virtual characters. Players (users) may be represented as avatars, two or three-dimensional graphical representations. Virtual worlds may be used for massively multiple online role-playing games, for social or business networking, or for participation in imaginary social universes.

In virtual worlds (video/computer games) a player character or playable character (PC) is a virtual character that is controlled or controllable by a player. A non-player character (NPC) is a virtual character that is controlled by the program and not a player. NPC may also refer to other entities not under the direct control of players. Prior art NPC behavior in virtual worlds is usually scripted and automatic, triggered by certain actions or dialogue with the player characters. NPCs are often distinguished from player characters by avatar appearance or other visual designation, and often serve as in-game support for new players.

Game developers strive to provide fully fleshed-out NPCs in role playing games (RPGs), because it is a general consensus that the more “real” the NPCs feel, the more fun players will have interacting with these virtual characters. One way of achieving this in some rare cases is to use NPCs that are largely unscripted, but in fact these NPCs are regular player characters (PCs) that are being controlled by the employees of the game company. This is a costly option to provide a better experience, and cannot be used widely.

As noted above, prior art virtual worlds have inherent limitations. The present invention seeks to overcome these limitations of the prior art by providing methods and systems that offer a richer and more unique gameplay experience for each player.

### SUMMARY

A computer-implemented method is provided for providing virtual gameplay on a computing device in communication with a storage means. Access is provided to a video game in which a player can create a player character for interaction in the video game. The player is allowed to play in the video game using the player character via at least one player character script. When the player exits the video game (i.e. when the player is not presently engaged in gameplay), the player character is allowed to at least temporarily become a non-player character in the game by selectively causing the player character to assume at least one non-player character script, such that the player character has automatic, non-player directed interactions in the video game wherein the player character takes on the behaviour of a non-player character. When the player returns to the video game, the player character is allowed to resume play in the video game according to the player character script.

Thus, a type of gameplay is proposed whereby the Player Characters (PCs) can be used as Non-Player Characters (NPCs). This enables a player to have a unique and more enjoyable gaming experience.

Various manipulations can be done to the player character script to cause the player character to assume the at least one non-player script. For instance:
the player character script may be at least temporarily replaced with at least one non-player character script;
the player character script may be at least temporarily combined or merged with at least one non-player character script;
in certain embodiments, each script may have at least two sub-components. These sub-components may be combined or replaced with each other to at least temporarily convert the player character to the non-player character;
the player character script may be at least temporarily combined or replaced with a script that has been downloaded, transferred, purchased, gifted, won, or lost, or restored or linked from another game.

In some embodiments, each sub-component may include at least one statistic. For example, the statistic may be a primary statistic or a derived statistic. In the case of a derived statistic, causing the player character to assume at least one non-player character script may include changing the formula or algorithm by which a derived statistic in the sub-component is derived.

When the player returns to the game, the non-player character script may be removed or disabled. Alternatively, the non-player character script may continue to influence the player character when the player returns to the video game.

The player character may accrue or lose property, points, weapons, levels, experience, health, advantage, loot, damage, slaves, minions, followers from the player character's automatic, non-player directed interactions.

Alternatively, the player character's state may be saved when the player exits the game, and the player character may be restored to that state when the player returns to the video game (i.e. uninfluenced by the player character's interactions during its NPC state).

Preferably, there is no change to the player character's appearance when the player character assumes the at least one non-player character script.

In some embodiments, the player character may retain the player character's accumulated property, points, weapons, levels, experience, health, advantage, loot, damage, slaves, minions, followers while the player character is assuming the at least one non-player character script.

In some embodiments, the player character retains a memory of the player character's interactions while assuming the at least one non-player character script. The memory of the player character's interactions may in certain embodiments be able to be recalled or replayed when the player returns to the video game.

The player character may be created with a signature move or signature style. In this case, the player character may be able to retain the signature move or signature style while the player character is assuming the at least one non-player character script.

In some embodiments, the video game has a population of default non-player characters in the video game. One default non-player character may be at least temporarily retired or removed from the video game when the player character assumes the at least one non-player character script.

Assuming the at least one non-player character script may be one way of preserving the health of the player character for when the player returns to the video game.

Where the video game is accessible by multiple players, each having a player character, those player characters may be able to interact or have encounters with a player character while the player character has assumed the at least one non-player character script. Players entering and exiting the game therefore slip in and out of “NPC mode” and thus the mix of NPCs is always changing depending on which players are not engaged in the gameplay of the virtual world.

For example, the virtual world may be seeded with NPCs at the inception (release) of the video game and as more players engage in gameplay and create PCs, these NPCs are retired to be replaced by the player created PCs. In a variation, each player created PC replaces one NPC that was created at inception.

This provides for a richer gaming experience and increases player engagement while making the gameplay of the virtual world more unique each time a player engages in the gameplay since the mix of the NPCs varies each time.

Preferably, the storage means is provided by one or a combination of: a local fixed memory, a local removable memory, a remote fixed memory, a remote removable memory, and a virtual memory.

The player may be able to elect not to allow the player character to become a non-player character. In some embodiments, the player can also define an extent to which the player character will be permitted to lose points or sustain damage (e.g. 10% maximum) when acting as a non-player character.

### BRIEF DESCRIPTION OF THE FIGURES

FIG. 1 is a flow diagram illustrating the primary steps of the method of a player character becoming a non-player character, according to a preferred embodiment.

FIG. 2 is a flow diagram illustrating the primary steps of the method of a player returning to the game and the player character being restored.

FIG. 3 is a flow diagram representing an example of how PC/NPC conversion may be used in a MMORPG context.

FIG. 4 is a flow diagram representing an example of how NPCs may be retired as PCs enter a virtual world in a MMORPG context.

FIG. 5 is an illustrative notional data structure showing statistics of a virtual character and possible combinations of statistics to evolve the virtual character.

FIG. 6 is an illustrative notional data structure showing statistics of a virtual character and possible combinations of statistics to evolve the virtual character.

### DETAILED DESCRIPTION

Methods and arrangements of using Player Characters (PCs) as Non-Player Characters (NPCs) for gaming applications and virtual worlds are disclosed in this application.

Before embodiments are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A “virtual world” as used herein need not be a “game” in the traditional sense of a competition in which a winner and/or loser is determined, but rather that the term “game” incorporates the idea of a virtual world. Moreover, a person or entity that enters the virtual world in order to conduct business, tour the virtual world, or simply interact with others or the virtual environment, with or without competing against another person or entity is still considered to be “playing a game” or engaging in the gameplay of the game.

Virtual worlds can exist on game consoles for example Microsoft Xbox, and Sony Playstation, Nintendo Wii, etc., or on online servers, or on mobile devices (e.g. an iPhone or an iPad), Smartphones, portable game consoles like the Nintendo 3DS, or on a PC (personal computer) running MS Windows, or MacOS, Linux or another operating system. This list is not exhaustive but is exemplary of devices or computing environments where virtual worlds can exist, many other variations are available and known to the ones skilled in the art.

A computer or a game console that enables a user to engage with a virtual world, including a memory for storing a control program and data, and a processor (CPU) for executing the control program and for managing the data, which includes user data resident in the memory including a set of gameplay statistics. The computer, or a game console, may be coupled to a video display such as a television, monitor, or other type of visual display while other devices may have it incorporated in them (iPad). A game or other simulations may be stored on a storage media such as a DVD, a CD, flash memory, USB memory or other type of memory media. The storage media can be inserted to the console where it is read. The console can then read program instructions stored on the storage media and present a game interface to the user.

Typically, a user or a player manipulates a game controller to generate commands to control and interact with the virtual world. The game controller may include conventional controls, for example, control input devices such as joysticks, buttons and the like. Using the controller a user can interact with the game, such as by using buttons, joysticks, and movements of the controller and the like. This interaction or command may be detected and captured in the game console. The user's inputs can be saved, along with the game data to record the game play. In one embodiment, the gameplay data can include usage statistics captured to record the user's experience as they progress from one level of the game to the next.

The term “player” is intended to describe any entity that accesses the virtual world, regardless of whether or not the player intends to or is capable of competing against other players. Typically, a player will register an account with the game console within a peer-to-peer game and may choose from a list or create virtual characters that can interact with other virtual characters of the virtual world.

The term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity.

Virtual Character—may include a persona created by a player or chosen from a list in the virtual world. Typically virtual characters are modeled after the humans whether living or fantasy (e.g. characters from mythology). In this disclosure the term virtual character is used interchangeably with villain, boss, monster etc. but the intent is to mean any kind of a virtual character whether it is a protagonist or an antagonist, celebrity, champion, conqueror, charlatan, daredevil, entrepreneur, explorer, fortune-hunter, gambler, globetrotter, hero, heroine, hobbit, madcap, mercenary, magician, mage, opportunist, pioneer, pirate, romantic, speculator, stunt person, swashbuckler, traveler, voyager, wanderer or the like.

A virtual character is represented by one or more gameplay statistics, which encapsulate some meaning to connect the virtual (and digital) reality of the game to the real world. Many of these statistics are not apparent to the user as such, but are instead encoded within the framework of the game or composed together to form a script. In role-playing games (RPGs) and similar games, these statistics may be explicitly exposed to the user through a special interface, often with added meaning which provides context for the user's actions.

A player character or playable character (PC) is a virtual character in a virtual world that is controlled or controllable by a player. A player character is a persona of the player who controls it. In some cases a virtual world has only one player character and in other cases there may be a small number of player characters from which a player may pick a certain virtual character that may suit his or her style of gameplay, while in other scenarios there may be a large number of customizable player characters available from which a player may choose a virtual character of their liking. An avatar—may include the physical embodiment of a virtual character in the virtual world.

In virtual worlds (video/computer games) a non-player character (NPC) is a virtual character that is controlled by the program and not a player. NPC may also refer to other entities not under the direct control of players. NPC behavior in a virtual world may be scripted and automatic.

The system and method described in the patent disclosure is equally applicable to any type of a virtual character whether it is protagonist or an antagonist, male or female, or any other kind of virtual character.

Statistics (Stat)

A statistic (stat) in role-playing games (RPG) is a datum which represents a particular aspect of a virtual character. Most virtual worlds separate statistics into several categories. The set of categories actually used in a game system, as well as the precise statistics within each category may vary greatly from one virtual world to another. Many virtual worlds also use derived statistics whose values depend on other statistics, which are known as primary or basic statistics. Derived statistics often represent a single capability of the character such as the weight a character can lift, or the speed at which they can move. Derived statistics are often used during combat, can be unitless numbers, or may use real-world units of measurement such as kilograms or meters per second.

Primary Statistics represent assigned, abstract qualities of a virtual character, such as Strength, Intelligence, and so on. Partially defined by convention and partially defined by context, the value of a primary statistic corresponds to a few direct in-game advantages or disadvantages, although a higher statistic is usually better. In this sense, primary statistics can only really be used for direct comparison or when determining indirect advantages and disadvantages.

Derived Statistics represent measured, concrete qualities of a virtual character, such as maximum carry weight, perceptiveness, or skill with a weapon. Such a stat is derived from some function of one or more of a character's primary stats, usually addition or multiplication. These stats then serve an important function in turn, providing a fair means by which to arbitrate conflicts between virtual characters and the virtual environment. For example, when two virtual characters are in violent conflict, Strength, a primary statistic, might be used to calculate damage, a derived statistic, with the winner being the character that has inflicted the most damage.

Other factors may affect derived statistics, such as other derived or primary statistics, or even environmental factors, such as weather conditions. In these cases, the environment can be modeled as a virtual character with its own primary statistics or it may be given a special role in conflict resolution. Whatever-the-case, the role of primary statistics should remain clear because this is the primary interface by which players understand their interactions within the virtual world.

Some statistics deserve special mention. “Health (or Hit Points) vs. Damage,” describes a gameplay mechanic that has fixated the current generation of games. Damage refers to a primary or (usually) derived statistic that represents a character's ability to destroy or cause harm to the environment or virtual characters. Likewise, Health (or Hit Points) refers to a primary or (usually) derived statistic that represents a character's ability to withstand damage and continue to function normally. Each time a character suffers damage, that amount of damage is subtracted from their remaining health or hit point total, and if this total is now zero or less, the character is eliminated or the player loses.

A virtual character's statistics affects how it behaves in a virtual world. For example, a well-built muscular virtual character may be more powerful and be able to throw certain virtual objects farther, but at the same time may lack dexterity when maneuvering intricate virtual objects. A virtual character may have any combination of statistics, but these statistics may be limited by either a hard counter, soft counter or a combination of both. The most often used types of statistic include but are not limited to the following:

Attribute/Ability

An attribute/ability describes to what extent a virtual character possesses a natural, in-born characteristic common to all virtual characters in the game. Ability defines a quality in a virtual character to perform certain actions, for example wield a sword or to run. Many games use attributes to describe a virtual characters' physical and mental characteristics, for example their strength or wisdom. Many games also include social characteristics as well, for example a character's natural charisma or physical appearance which often influence the chance to succeed in a particular challenge. Some games work with only a few broad attributes, while others may have several more specific ones.

Trait

Traits may be stable personal characteristics (i.e., temperament or physical endowment) that are additional qualities that help define a virtual character. Traits can be positive or negative. Traits also affect the ability to build particular skills. For instance, an active virtual character will find it easier to develop a more muscular body than an inactive one. Generally a trait represents a broad area of expertise of a character.

Skills

A skill represents the learned knowledge of a virtual character. Skills are manifestations of abilities and traits. During the creation of a virtual character, skills are generally chosen from a list. A virtual character may have a fixed number of starting skills, or a player can acquire them by spending game points. Each skill has an associated attribute and can be improved upon by practicing. For example if a virtual character has the ability to wield a sword and has the trait of being physically strong then the skill of being a swordsman can be accomplished by practicing wielding the sword. As opposed to abilities few games set a player's skills at the start of the game, instead allowing players to increase them by playing the game and spending game points or during moving from a low level to a higher level in the game. Some skills are likely to be more useful than others therefore different skills often have different costs in terms of game points.

Advantages and Disadvantages

An advantage is a physical, social, intellectual, or other enhancement to a virtual character, while a disadvantage is an adverse effect. Advantages are also known as virtues, merits or edges and disadvantages as flaws or hindrances. Many games encourage or even force players to take disadvantages for their characters in order to balance their advantages or other positive statistics.

Powers

Powers represent unique or special qualities of a virtual character and often grant the virtual character the potential to gain or develop certain advantages or to learn and use certain skills.

For the purpose of this application the term “gameplay statistics” refers to any one or any combination of gameplay frequency, gameplay time, number of times game played, percent game complete etc. as result of engaging in gameplay.

Encounters

In a virtual world an encounter may be defined as a meeting between two or more virtual characters or may be thought of as a decision point at which a player encounters an opposing element (e.g. an enemy). An encounter may be player initiated (actively engaging in fighting an enemy) or unwanted by the player. A player may opt to avoid an encounter or may actively engage in them to move to the next level of the virtual world. The outcome of the encounters may at times define how the rest of the game progresses.

A random encounter is a feature commonly used in various role-playing games (RPGs) whereby an encounter with a non-player character (NPC), an enemy, a monster, or a dangerous situation occurs sporadically and at random. Random encounters are generally used to simulate the challenges associated with being in a hazardous environment, such as a monster-infested wilderness or dungeon usually with an uncertain frequency of occurrence to simulate a chaotic nature.

Settings

Settings in the virtual world control multiple areas of the virtual world (game). Settings may be changed by a player or may be impacted by the location of a player.

Levels

A level in the virtual world (video game) terminology refers to a discrete subdivision of the virtual world. Typically a players begins at the lowest level (level 1), and proceeds through increasingly numbered levels, usually of increasing difficulty, until they reach the top level to finish the game. In some games levels may refer to specific areas of a larger virtual world, while in other games it may refer to interconnected levels, representing different locations within the virtual world.

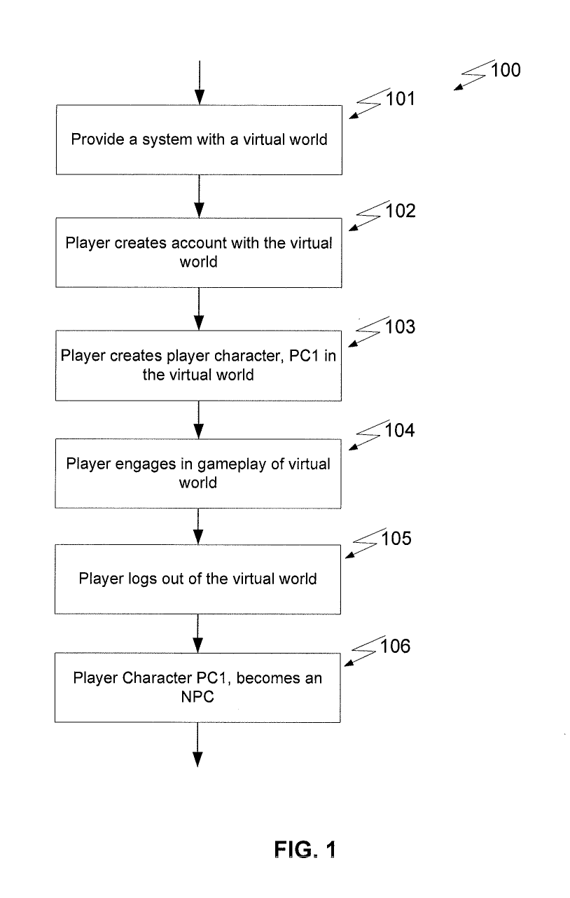

FIG. 1 shows a flow diagram illustrating the primary steps of the method of a player character becoming a non-player character, according to a preferred embodiment.

A system is provided with a virtual world 101. The virtual world may be a single player game or a multiplayer game or a MMORPG (Massively Multiplayer Online Role Playing Game) and may exist on any type of a gaming device which may include but not limited to an iPhone, iPad, Smartphones, Android phones, personal computers e.g. laptops, gaming consoles like Nintendo Wii, Nintendo DS, Sony PlayStation, Microsoft Xbox 360, and online server based games etc.

The computer program comprises: a computer usable medium having computer usable program code, the computer usable program code comprises: computer usable program code for enabling change in storyline based on the real world location of a player, computer usable program code for presenting graphically to the player the different options available to modify and personalize different aspects of the virtual world including but not limited to settings.

A player creates an account with the virtual world 102. The player may have to provide a user name and a password along with other personal or financial information in order to create an account with a virtual world. Personal information for example may include providing address and date of birth. Financial information may include providing a credit card number and billing address if it is a subscription based or paid game. Creating a player account is a well understood method in prior art.

The player creates a player character PC1 in the virtual world 103. Creating a player character is a well understood method in prior art.

The player engages in gameplay of the virtual world 104. As mentioned earlier, the term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity. The player may use any one of the several possible mechanisms to interact with the virtual world including but not limited to a gamepad, keyboard, mouse, joystick, wired game controller, wireless remote game controller or other such mechanism.

The player logs out of the virtual world 105. A player may log out by clicking on a log out button in order to leave the virtual world and disengage from the gameplay. This is a well understood method in the prior art.

After the player logs out (or, in certain embodiments, goes inactive without logging out from the virtual world), player character PC1 becomes an NPC 106. In one embodiment, the behavior of a PC1 virtual character may be altered by changing the default script that is controlling the behavior of the virtual character. A script defines the default behavior of a virtual character. If there is no external stimulus a virtual character acts as per the default script. Just as with statistics, different scripts can refer to different behaviors for virtual characters. In one embodiment, when using a PC as an NPC, an alternate string may be used. Such a string may already be present in the virtual world so that the player state, stats, health and other preferences are maintained in a state where the player left off when the player logged off from the virtual world.

Even with a default script of a single virtual character, many behaviors are possible. In fact, the manner by which derived statistics are calculated can itself be defined by a particular script, rather than a simple function. For this reason, it is sometimes difficult to determine whether a derived statistic refers more to a particular measurable quality or the behavior that defines that quality. For example, a skill may be represented by a statistic where a higher value corresponds to a higher degree of skill in some particular endeavor. However, a trait may refer to the behavior that defines that trait, rather than simply a statistic. In this way, it is important to distinguish when skills, traits, abilities, and other game components are represented by statistics or behaviors.

In another embodiment, new strings can be obtained by combining stats from more than one script (or strings) associated with the virtual character, and the new string can be saved to the preferred memory location. Most devices where virtual worlds exist provide a mechanism to save the state of the game, so that the game can be played from the same point where it was left off. Methods for saving the state of the game include but are not limited to the examples cited here, for example games played over the Internet may provide online memory e.g. save the new string to the server.

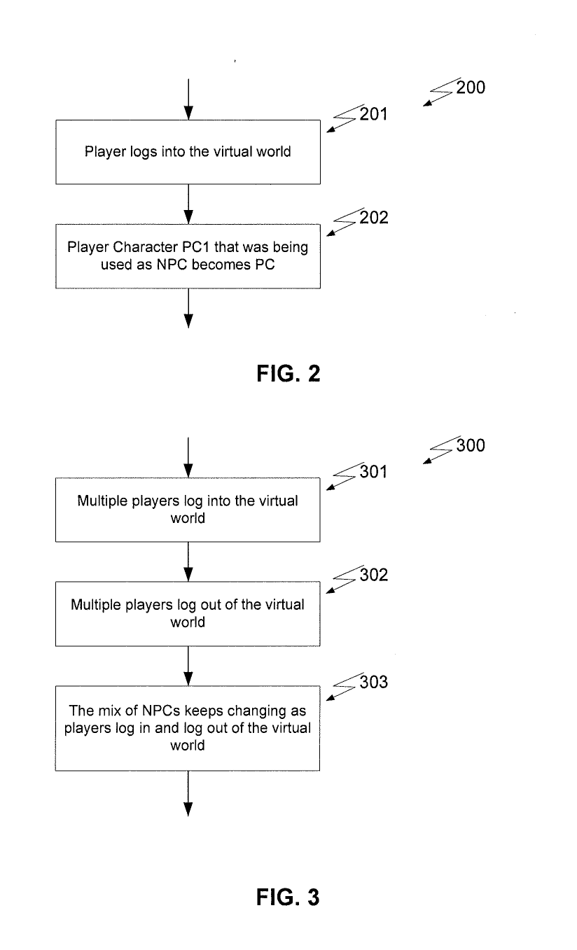

Turning to FIG. 2, the player logs into the virtual world 201. The player may have to provide a user name and a password in order to log into the virtual world.

Player Character PC1 that was being used as an NPC becomes (or is restored as) a PC 202. As explained earlier, by replacing the string the behavior of a virtual character can be altered. Thus the string where the player game stats and other preferences are stored may be used at this point, so that the virtual character that was acting like an NPC may start to behave (or resume behaving) like the personalized PC that the user created.

Turning to FIG. 3, multiple players may log into the virtual world 301. In one embodiment, where the system is implemented as a MMORPG (Massively Multiplayer Online Role Playing Game) or as an online server based game, there may be multiple players engaged in the gameplay at any given time.

Multiple players may log out of the virtual world 302. Since there are multiple players engaged in the gameplay of the MMORPG, usually from various parts of the world spread over many different time zones, there are always players logging out at various instances.

Thus, according to the method, the mix of NPCs keeps changing as players log in and log out of the virtual world 303, thus providing a unique gaming experience for each player over a period of time.

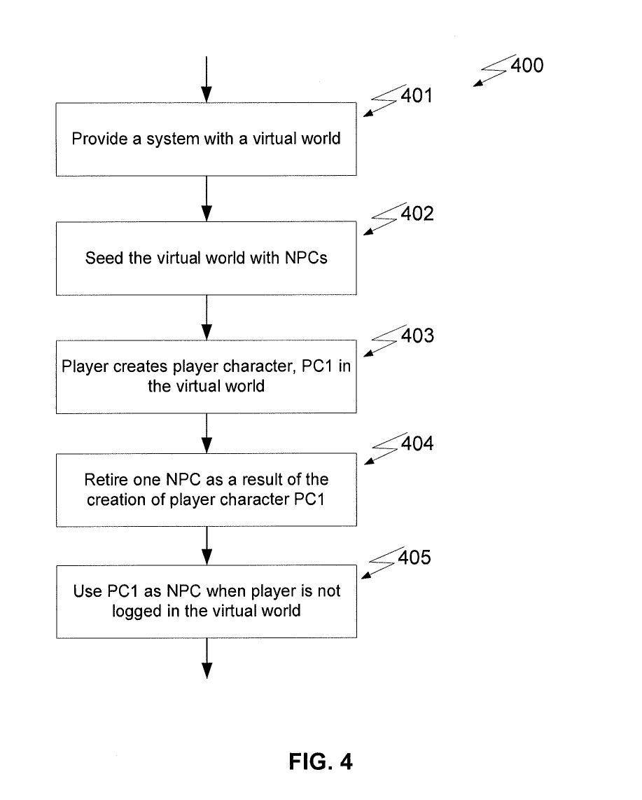

FIG. 4 shows retiring NPCs as PCs are introduced onto the virtual world over a period of time 400.

A system is provided with a virtual world 401. The virtual world is seeded with NPCs 402. Seeding the virtual world implies that the developer may add NPCs to the virtual world at the time of release, but these NPCs may not be fully flushed out and may simply provide a useful starting point for the players to start engaging in the gameplay and creating their own PCs.

A given player creates a player character, PC1, in the virtual world 403. In one embodiment, one NPC is retired as a result of the creation of player character PC1 404. In another embodiment, the creation of one PC may result in the retiring of more than one NPC. Likewise, the creation of several PC's may result in the retiring of one NPC.

PC1 can be used by the system as an NPC when player is not logged in the virtual world 405. In one embodiment, the newly created player character PC1 can be used as an NPC when the player who created PC1 is not logged into the virtual world.

In one embodiment, the intent is to preserve the Health of a PC while it is being used as an NPC.

Health is a game mechanic used in virtual worlds to give a value to virtual characters, enemies, NPCs, (non player characters) and related virtual objects. Health is often abbreviated by HP which may stand for health points or hit points; it is also synonymous with damage points or heart points. In virtual worlds health is a finite value that can either be numerical, semi-numerical as in hit/health points, or arbitrary as in a life bar, and is used to determine how much damage (usually in terms of physical injury) a virtual character can withstand when said virtual character is attacked, or sustains a fall. The total damage dealt (which is also represented by a point value) is subtracted from the virtual character's current HP. Once the virtual character's HP reaches 0 (zero), the virtual character is usually unable to continue to fight or carry forward the virtual world's mission.

A typical life bar is a horizontal rectangle which may begin full of color. As the virtual character is attacked and sustains damage or mistakes are made, health is reduced and the colored area gradually reduces or changes color, typically from green to red. At the start of a typical game, the virtual character may have 100% health. At some point the life bar changes color completely, or loses color; at this point the virtual character is usually considered dead.

In one embodiment, the PC virtual character can be changed to a NPC virtual character by replacing the default script with another script that may be embedded in the virtual world and associated with the PC virtual character.

In an alternate embodiment, the PC virtual character can be changed to a NPC virtual character by creating a new string by combining the stats of two or more strings that may be present in the virtual world and associated with the PC virtual character.

In an alternate embodiment, the players may be actively involved in how their PCs behave when being used as NPCs by exercising some degree of control over the behavior by being able to modify these strings. Thus in alternate embodiments the strings may also be downloaded from a server, purchased, sold, exchanged, gifted, won, lost, etc.

In another embodiment the scripts associated with different virtual characters may be downloaded (either automatically or by player request) from a central server that acts as a repository for additional scripts. In yet another embodiment the player may have to pay when acquiring these additional scripts e.g. from a remote server.

The invention is not limited to these examples, but the intent is to cover all such possibilities that are obvious to persons skilled in the art.

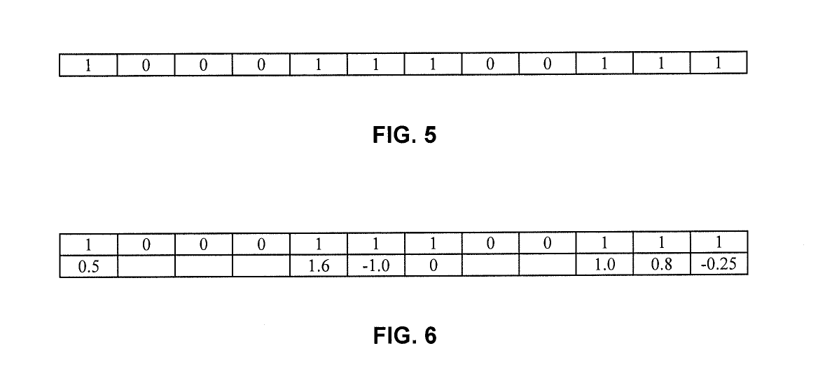

In one embodiment, the presence or absence of a Skill, Ability, Trait, Advantage, Disadvantage or Power is represented by a “1” or a “0” respectively. One exemplary data structure that may be used to define a virtual character's statistics is shown in FIG. 5.

The data fields may be arranged in a given order, so that the statistics from one string associated with a virtual character in a virtual world correspond to the same statistics in another string for the same virtual character in the same virtual world. In another embodiment there may be a mapping mechanism that may translate the statistics of one string associated with a virtual character to that of another string associated with the same virtual character. The data structure may be a file e.g. an XML file, or a table, or a database, or a string.

The data structure fields may be ordered to allow different strings associated with a virtual character to correspond uniformly to one another. For example, “Strength” may be the first field in this ordering, “Wisdom” may be the second field and so on. Therefore, when one or more strings associated with a virtual character are combined, statistics for the relevant data fields are composed by some function, for example in one case Strength is added to Strength, while Wisdom from one string is subtracted from the value of Wisdom in another string.

In another embodiment, there may be mapping that allows the data structure fields to be mapped indirectly from one to the other so that the relevant data fields correspond with each other. This is especially relevant for derived statistics. For example, if the “Dodge Skill” in one string is composed of the “Dexterity” primary statistic and a “Dodge Training” secondary statistic, and the “Reflex Save” derived statistic in another string is composed of “Dexterity” and “Perception” primary statistics, then the “Dodge Skill” and “Reflex Save” can be composed when combining the stats from these strings.

In another embodiment, where there may be a non-uniform number of data fields (say one set of statistics has 5 data fields and the other set of statistics has 8 data fields), the mapping allows for the relevant data fields to correspond. Thus the combined string may take all or some of the stats when creating a new string to change the behavior of the virtual character.

For each of the statistics that are present in a virtual character, there may be a corresponding value that defines the extent of that particular statistic. For some statistics, the possible range of values may include positive numbers, zero and negative numbers. Thus when the value is a positive number there may be a beneficial effect (positive effect), while a zero implies no effect and a negative number implies a negative effect. One such exemplary data structure showing a string of statistics associated with a given virtual character is shown in FIG. 6. The top row shows the presence or absence of a particular statistic while the second row shows a value that defines the quality of that particular statistic if it is present.

Thus, there may be several different methods of combining stats of different strings, for example in one embodiment while some statistics are added, others are deleted or subtracted as a result of combining two or more strings associated with the same virtual character. The resultant stats can be saved as a new string which later may be used for combining with previously existing strings.

In one embodiment, there may be more than one default script associated with a certain PC virtual character and are already embedded in a virtual world (game), but they may be dormant until invoked when a player is offline and the virtual character is being used as a NPC. In one embodiment, there may be generic scripts associated with each of the PC created by the players such that the generic strings are used when said PC virtual characters are used as NPCs.

The application is not limited to the cited examples, but the intent is to cover all such areas that may be used in a virtual world to impact the evolution of virtual characters in a virtual world.

A script defines the default behavior of a virtual character. Just as with statistics, different scripts can refer to different behaviors. Using the method and system, a default script of a virtual character may define its default behavior and in order to implement an altered behavior associated with a change in location a certain other script may be used instead of the default script of a virtual character.

It should be understood that although the terms “script” and “string” have been used interchangeably to imply the mechanism for altering the behavior of the virtual character, the intent is to cover all such mechanism that can provide this functionality.

One embodiment may preferably also provide a framework or an API (Application Programming Interface) for virtual world creation that allows a developer to incorporate the functionality of evolving virtual characters as more players interact with them. Using such a framework or API allows for a more exciting virtual world generation, and eventually allows for more complex and extensive ability to keep a player engaged over a longer duration of gameplay.

It should be understood that although the term game has been used as an example in this application but in essence the term may also imply any other piece of software code where the embodiments, are incorporated. The software application can be implemented in a standalone configuration or in combination with other software programs and is not limited to any particular operating system or programming paradigm described here. For the sake of simplicity, we singled out game applications for our examples. Similarly we described users of these applications as players. There is no intent to limit the disclosure to game applications or player applications. The terms players and users are considered synonymous and imply the same meaning. Likewise, virtual worlds, games and applications imply the same meaning Thus, this application intends to cover all applications and user interactions described above and ones obvious to persons skilled in the art.

Although virtual world have been exemplified above with reference to gaming, it should be noted that virtual worlds are also associated with many industries and applications. For example, virtual worlds can be used in movies, cartoons, computer simulations, and video simulations, among others. All of these industries and applications would benefit invention.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

What is claimed is:

1. A computer-implemented method of providing virtual gameplay on a computing device in communication with a storage means, the method comprising the steps of:
providing access to a video game in which a player can create a player character for interaction in the video game;
allowing the player to play in the video game using the player character via at least one player character script;
when the player exits the video game, allowing the player character to at least temporarily become a non-player character in the game by selectively causing the player character to assume at least one non-player character script, such that the player character has automatic, non-player directed interactions in the video game wherein the player character takes on the behaviour of a non-player character; and
when the player returns to the video game, allowing the player character to resume play in the video game according to the player character script.

2. The method of claim 1, wherein causing the player character to assume at least one non-player character script includes at least temporarily replacing the player character script with at least one non-player character script.

3. The method of claim 1, wherein causing the player character to assume at least one non-player character script includes at least temporarily combining or merging the player character script with at least one non-player character script.

4. The method of claim 1, wherein each script has at least two sub-components and wherein causing the player character to assume at least one non-player character script includes at least temporarily combining or replacing at least one of the sub-components of one script with sub-components of the other script.

5. The method of claim 4, wherein each sub-component includes at least one statistic.

6. The method of claim 5, wherein the statistic is a primary statistic or a derived statistic.

7. The method of claim 6, wherein causing the player character to assume at least one non-player character script includes changing the formula or algorithm by which a derived statistic in the sub-component is derived.

8. The method of claim 1, wherein causing the player character to assume at least one non-player character script includes combining or replacing the script with a script that has been downloaded, transferred, purchased, gifted, won, or lost, or restored or linked from another game.

9. The method of claim 1, wherein the non-player character script is removed or disabled when the player returns to the video game.

10. The method of claim 1, wherein the non-player character script continues to influence the player character when the player returns to the video game.

11. The method of claim 1, wherein the player character can accrue or lose property, points, weapons, levels, experience, health, advantage, loot, damage, slaves, minions, followers from the player character's automatic, non-player directed interactions.

12. The method of claim 1, wherein the player character's state is saved when the player exits the game, and the player character is restored to that state when the player returns to the video game.

13. The method of claim 1, wherein there is no change to the player character's appearance when the player character assumes the at least one non-player character script.

14. The method of claim 1, wherein the player character retains the player character's accumulated property, points, weapons, levels, experience, health, advantage, loot, damage, slaves, minions, followers while the player character is assuming the at least one non-player character script.

15. The method of claim 1, wherein the player character retains a memory of the player character's interactions while assuming the at least one non-player character script.

16. The method of claim 15, wherein the memory of the player character's interactions can be recalled or replayed when the player returns to the video game.

17. The method of claim 1, wherein the player character is created with a signature move or signature style and the player character retains the signature move or signature style while the player character is assuming the at least one non-player character script.

18. The method of claim 1, wherein the video game has a population of default non-player characters in the video game and wherein one said default non-player character is at least temporarily retired or removed from the video game when the player character assumes the at least one non-player character script.

19. The method of claim 1, wherein assuming the at least one non-player character script preserves the health of the player character for when the player returns to the video game.

20. The method of claim 1, wherein the video game is accessible by multiple players, each having a player character, and wherein those player characters can interact or have encounters with the player character while the player character has assumed the at least one non-player character script.

21. The method of claim 1, wherein the storage means is provided by one or a combination of: a local fixed memory, a local removable memory, a remote fixed memory, a remote removable memory, and a virtual memory.

22. The method of claim 1, wherein the player can elect not to allow the player character to become a non-player character.

23. The method of claim 1, wherein the player can define an extent to which the player character will be permitted to lose points or sustain damage when acting as a non-player character.
